(19) United States
(12) Patent Application Publication
(10) Pub. No.: US 2018/0165940 A1
(43) Pub. Date: Jun. 14, 2018

(54) SHOPPING RECEPTACLE SYSTEM AND METHOD

(71) Applicant: Claude L. Nassif, Laguna Niguel, CA (US)

(72) Inventor: Claude L. Nassif, Laguna Niguel, CA (US)

(21) Appl. No.: 15/837,275

(22) Filed: Dec. 11, 2017

Related U.S. Application Data
(60) Provisional application No. 62/432,536, filed on Dec. 9, 2016.

(51) Int. Cl. G08B 21/18; H04W 4/02

(52) U.S. Cl. CPC G08B 21/182; G06Q 30/0633; H04W 4/023

(57) ABSTRACT

A grocery bag tracking and alerting framework enables consumers to monitor and locate their supply of grocery bags when they are in need of such bags for shopping excursions. The framework interrogates one or more elements to identify and locate grocery bags in the vicinity of the user, and alerts the user of their presence when needed. The framework also provides users with information regarding a quantity of bags, type of bags, size of bags, and when the number is less than a predetermined number of a preferred supply. The framework also correlates a number and type of bag with shopping list or needed items.

### CROSS-REFERENCE TO RELATED PATENT APPLICATION(S)

This patent application claims priority to U.S. provisional application 62/432,536, filed on Dec. 9, 2016, the contents of which are incorporated in their entirety herein. In accordance with 37 C.F.R. § 1.76, a claim of priority is included in an Application Data Sheet filed concurrently herewith.

### FIELD OF THE INVENTION

The present invention relates to receptacles, such as bags or boxes, for carrying items such as groceries or the like. Specifically, the present invention relates to reminding users to bring along with them such a receptacle when leaving the home or entering an establishment at which goods can be purchased and placed within such a receptacle.

### BACKGROUND OF THE INVENTION

In one aspect, the present invention relates to a system and method for detection and alerting a user of the number and location of a personal effect. In one example the personal effect can be a receptacle for use while visiting a business establishment. More specifically, the system and method can relate to and incorporate a computing device, such as, but not limited to a mobile or smartphone, laptop, tablet and other such computing device, upon which, within or associated with is one or more software applications for detecting an electronically detectable element, such as, for example, an RFID tag, that is incorporated within or on the personal effect. Additionally, the computing device may include software for determining the location of the computing device, such location capabilities can include utilization of a global positioning system (GPS) to determine a present location of the computing device and the personal effect, the computing device being further capable of determining its location relative to the personal effect, as well as to other tagged or pre-identified locations and/or objects. The computing device is, in particular embodiments, capable of utilizing internet networks, the WEB or other networks and GPS and FRIS technologies, as is appropriate and useful.

A current push for green/environmentally friendly policies has expectedly resulted in many new aspects of everyday living for the general population. In accordance with such policies, particular laws, rules and regulations have been passed in order to change various aspects of everyday living which have been decided to be detrimental to the health of planet earth. One such example is the use of disposable and/or single use receptacles, such as a plastic bags, the type typically found at retailers, such as grocery stores, for example. In particular jurisdictions, the use of such receptacles has even been banned. Further restrictions on the sale, number and use of currently utilized everyday items are possible and accordingly there is a need for methods and systems that optimize and facilitate such new approaches to everyday living.

In response and in one example, customers are now encouraged to bring into such establishments, retailers/stores (e.g. as supermarkets and grocery stores) their own personal effect, such as, for example a previously purchased receptacle which can include a single or plurality of receptacles. Not having brought such personal effects, for example bags, along with them to the store (for example, not remembering to bring the receptacle from home, or if brought from home (typically placed within their personal vehicle utilized to get to the establishment) forgetting to bring the receptacle along with them from their vehicle into the establishment) results in the common dilemma witnessed at checkout lines, that is, either the customer is faced with purchasing a bag from the establishment (which the user/customer does not need if already owning bags at home or in the car), carrying their purchased items in their arms out of the store, or humiliatingly asking other customers if they would kindly spare at least one of their receptacles that they had the presence of mind to bring with them into the establishment retailer/store.

### BRIEF SUMMARY OF THE INVENTION

The present invention generally relates to grocery bag tracking, and more specifically relates to a system and method for tracking or monitoring a grocery bag supply of a consumer, and informing the consumer of their presence when needed. The present invention comprises one or more systems and methods that may be configured to provide users with information regarding a quantity of bags, location of bags, type of bag, size of bag, and when the number is less than a predetermined number of a preferred supply.

It is one objective of the present invention to provide a system and method of tracking a user's personal effects. It is another objective of the present invention to provide a system and method for locating and informing a user of the presence and availability of personal effects such as shopping bags, particularly when needed for grocery or other shopping. It is another objective of the present invention to provide a system and method for correlating a number, presence, and location of grocery bags with a user's shopping excursion.

Other objects, embodiments, features and advantages of the present invention will become apparent from the following description of the embodiments, taken together with the accompanying drawing, which illustrates, by way of example, the principles of the invention.

### BRIEF DESCRIPTION OF THE SEVERAL VIEWS OF THE DRAWINGS

The accompanying drawings, which are incorporated in and constitute a part of this specification, illustrate several embodiments of the invention and together with the description, serve to explain the principles of the invention.

FIG. 1 is a flow chart of elements in a system and method for locating receptacles and reminding a user of their location and availability for use according to the present invention.

### DETAILED DESCRIPTION OF THE INVENTION

In the following description of the present invention reference is made to the exemplary embodiments illustrating the principles of the present invention and how it is practiced. Other embodiments will be utilized to practice the present invention and structural and functional changes will be made thereto without departing from the scope of the present invention.

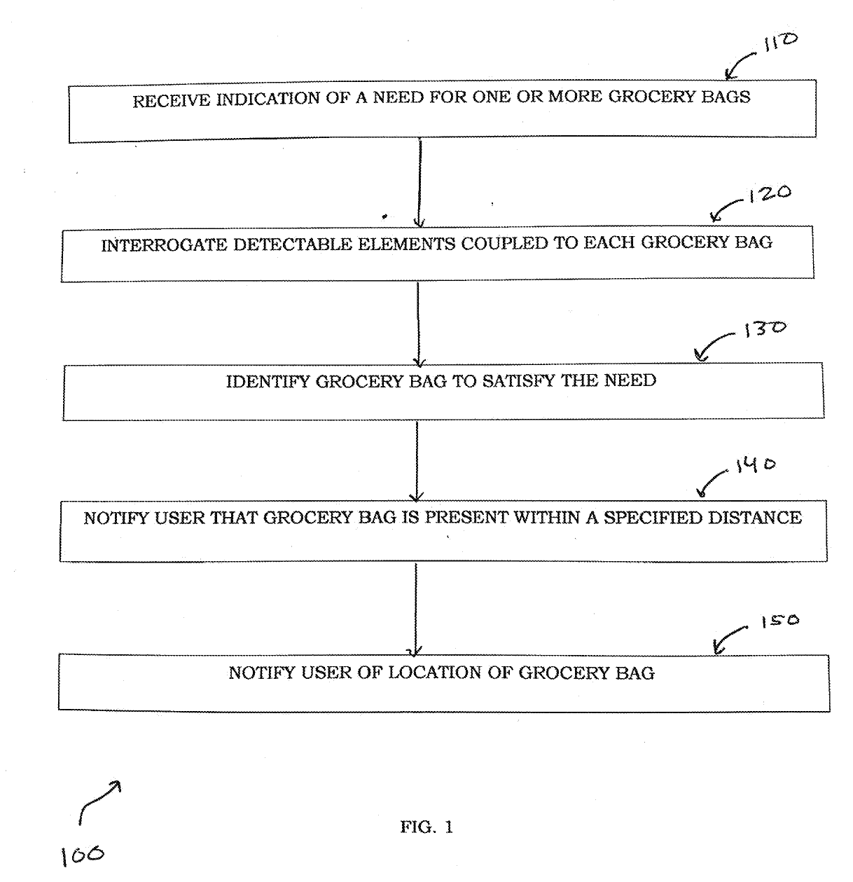

The present invention is exemplified in FIG. 1, which illustrates steps in a process 100 for performing a grocery bag tracking and alerting framework. The process includes the step 110 of receiving an indication of a need for one or more grocery bags, for example from a user's mobile phone, and/or either automatically or at the request of the user. The process 100 then interrogates one or more detectable elements coupled to each grocery bag in the one or more grocery bags at step 120, and identifies at least one grocery bag to satisfy the need for the one or more grocery bags at step 130. The process 100 then notifies a user at step 140 that the at least one grocery bag is present within a specified distance, and then notifies the user of the location of the at least one grocery bag at step 150.

The grocery bag tracking and alerting framework of the present invention is embodied in one or more systems and methods in which a person or user is reminded to bring along with them a desired personal effect. In one example, the personal effect is a receptacle, the receptacle having a detectable element. The receptacle may be a bag or box, made of any suitable material (for example, plastic, paper/cardboard or woven material) having the detectable element molded, sewn, adhered to or otherwise associated therewith or coupled thereto. Such detectable elements may be, in some embodiments, removable and/or associated with another receptacle. For example, a user may have a particular receptacle that is favored or is utilized under particular circumstances or times of the year, or the use of the receptacle may depend upon a particular type of item(s) that is to be placed within, (e.g. a mesh receptacle(s) for fresh produce, or a heavily woven receptacle(s) for carrying heavy items, or a plastic or paper receptacle depending upon the time of year or prevailing weather conditions). The detectable element may be an RFID tag or similar such detectable identifying element. In addition and in further accordance with the present disclosure, a computing device (for example, a mobile, cell, or “smart” phone, tablet or computer or similar device) includes means for interrogating and detecting the detectable element and thus is able to track the location of the personal effect, and keep count of the personal effect and the type thereof, as well as the origin of the personal effect and other information associated therewith.

In one example of the present invention, the computing device can detect, via an appropriate application (“app”) the type and number of receptacles present, such as a bag or box, within a predetermined minimal distance. Such a computing device may, via its app and in coordination with GPS information that is continually updated, determine that the computing device is at a person's home and thus detect, for example, the detectable elements of the receptacles within a home-related predetermined distance or area, such as, for example, if living in a small house, detecting all detectable elements associated with a single or plurality of receptacles within a short distance, for example 10 yards (if in a relatively larger house, for example, the distance queried can be increased, for example up to about 30 yards-50 yards or more). When the location of the computing device changes, for example from a person's home to within a person's transportation vehicle, the computing device, via a detectable element on/within the transportation vehicle, determines that it is now within the transportation vehicle, and queries for detectable receptacle-associated elements within a distance less than that distance associated/utilized in the house, such as for example, less than about 5 yards. The computing device, based on such queries, then displays to and informs the user of the number of personal effects, such as receptacles (for example, bags or boxes) located at the home and/or within the transportation vehicle accordingly. The display of such information can be customized according to the user's reference, such as by receptacle type, origin or other parameters (tensile strength, material from which receptacle is made, etc.).

Furthermore, and in one example in accordance with the teachings of the present disclosure, the computing device is capable of informing the user of the origin or association of the receptacles in possession, that is, the particular retail establishment from with or with which the receptacles are associated with. As a non-limiting example, after a query by the computing device, within the transportation vehicle, a display (e.g. the display can be a smartphone, tablet or car-mounted monitor/screen) may inform the user that “3 plastic bags from Vons®, 2 from Ralphs® and 3 from Whole Foods®” are available, displayed or vocalized by the computing device to inform the user of what bags are proximate, for example, in the truck or back seat or basically out of view of the user. Thus, the user is always informed of what receptacles are available within the vehicle, without the need for a distracting visual inspection.

In addition, and in further accordance with the present disclosure, the computing device, utilizing the information and/or identification gathered about the receptacles (for example, what retailer/store they are associated with and/or obtained from) within the transportation vehicle and in conjunction with, for example GPS information or other location information, may provide a user with a reminder or notice of, upon approaching a predetermined distance of at least one retailer/store (such as, for example, within about 1 mile, or more or less, of a particular retailer/store, the user having within the transportation vehicle a receptacle associated with that particular retailer/store). The present invention may also provide the user with at least one particular promotional offering/special is being made that week or day or month of the store the user is approaching (such as, for example, particular coupons for retail items, in one aspect such retail items can be included in the users phone as items that are regularly/previously purchased, for example) or that the user has “points” or “stamps” that have accrued in the user's customer file/account maintained by the retail/store establishment and that such reward points, or any such accrual, are about to expire and should be utilized/redeemed by the user at the retailer/store that the transportation vehicle is approaching.

In another aspect, the computing device determines what receptacles are within the transportation vehicle via its associated app and the detection of the detectable element associated with each receptacle. It then calculates and determines a set distance between the user and the at least one receptacle, the set distance being the distance between the user and the receptacle after a predetermined time of movement (TOM), that is, the computing device determines a distance between itself (the computing device being typically handheld or within less than about 6 feet of the user) and the receptacle(s) upon detecting (via its GPS capabilities) movement of both the computing device and the detected receptacle(s) relative to the surrounding environment within which the transportation vehicle travels. Here, both the computing device and the detected receptacle(s) may be relatively stationary to each other, relatively stationary meaning, for example, small movements of the computing device, such as smart phone in a pocket or jacket of a user shifting in a seat relative to the receptacle(s)).

In a further aspect, the computing device via GPS and/or some retailer/store-related signal determines that it is in proximity to a retailer/store (such info either provided by a mapping App or a previously selected location by the user) and in one example the cell/smartphone, can then, upon parking/stopping the transportation vehicle at a retailer/store, detects, via a signal (for example, GPS and/or via queries to the receptacle(s), an increase in the previously determined set distance between the user and the at least one receptacle (indicating that the user walking away from the vehicle), and thus triggers an alert to the user that they are leaving the detected receptacle behind and that they should stop and retrieve the receptacle(s) from the transportation vehicle. Of course, such an alert can be ignored and silenced by the user, as in the instance where they are not necessarily visiting the proximate retailer/store or just going in to look around, and thus do not need a receptacle such as a shopping bag. Such an alert can also be, in another aspect, triggered by the user carrying the computing device a predetermined distance from the transportation vehicle (the transposition vehicle having its own dedicated detectable element) in combination of without having the receptacles in close proximity to the user (for example, within 5 feet or 4 ft or 3 ft or 2 ft or less). That is, in one aspect, the computing device detects the shortening of the set distance as evidence that the user has/is taking the receptacle along with them to the retailer/store and thus does not trigger the alert to return to the transportation vehicle. This thus remedies the problem of leaving such environmentally-friendly/reusable receptacles in a user's transportation vehicle as the user shops and having to unnecessarily purchase or obtain additional receptacles, such as shopping bags upon checkout. Thus reduces the wasted money on additional receptacles as well as reduces the number of unutilized and disposed-of bags that are becoming the bane of current shopping excursions.

As noted above, the present invention may include providing users with information regarding a quantity of bags, location of bags, type of bag, size of bag, and when the number is less than a predetermined number of a preferred supply. In one embodiment, the present invention may correlate a shopping list, for example from a user's mobile phone or pulled from a connected social media account, and may compare the shopping list with the number of available bags to inform the user whether or not there are enough bags present in the home or vehicle to accommodate the entire shopping list. In this manner, the present invention may be configured to notify the user of how many additional shopping bags need to be purchased in the store to accommodate the entire shopping list. In a further embodiment, the present invention may include correlating items to be purchased with types and sizes of bags. For example, if a number of frozen items are desired to be purchased, the present invention may specifically interrogate the electronically-detectable elements for insulated bags that are capable of maintaining frozen items in a frozen state for longer. In still another embodiment, the present invention may also interrogate a refrigerator for its contents, and suggest to the user one or more items to purchase based on the number of available grocery bags.

The foregoing descriptions of embodiments of the present invention have been presented for the purposes of illustration and description. It is not intended to be exhaustive or to limit the invention to the precise forms disclosed. Accordingly, many alterations, modifications and variations are possible in light of the above teachings, may be made by those having ordinary skill in the art without departing from the spirit and scope of the invention. It is therefore intended that the scope of the invention be limited not by this disclosure. It must be expressly understood that the invention includes other combinations of fewer, more or different elements, which are disclosed above even when not initially claimed or described in such combinations.

The words used in this specification to describe the invention and its various embodiments are to be understood not only in the sense of their commonly defined meanings, but to include by special definition in this specification structure, material or acts beyond the scope of the commonly defined meanings.

The definitions of the words or elements of the present disclosure, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements of the invention or that a single element may be substituted for two or more elements of an invention. Although elements may be described above as acting in certain combinations, it is to be expressly understood that one or more elements from a described combination can in some cases be excised from the combination and that the described combination may be directed to a subcombination or variation of a subcombination.

Insubstantial changes from the disclosed subject matter as viewed by a person with ordinary skill in the art, now known or later devised, are expressly contemplated as being equivalently within the scope of the instant disclosure. Therefore, obvious substitutions now or later known to one with ordinary skill in the art are defined to be within the scope of the defined elements.

The present invention may be thought of as incorporating various types of input data, and these may be applied to a plurality of data processing components within a computing environment in which the systems and methods described herein are performed for additional processing, such as applying one or more mathematical functions or models, or one or more artificial intelligence models. The computing environment may include one or more processors and a plurality of software and hardware components, and the one or more processors and plurality of software and hardware components may be configured to execute program instructions or routines to perform the functions performed within the plurality of data processing components.

The systems and methods of the present invention may be implemented in many different computing environments. For example, the system and method for detection and alerting a user of the number and location of a personal effect may be implemented in conjunction with a special purpose computer, a programmed microprocessor or microcontroller and peripheral integrated circuit element(s), an ASIC or other integrated circuit, a digital signal processor, electronic or logic circuitry such as discrete element circuit, a programmable logic device or gate array such as a PLD, PLA, FPGA, PAL, and any comparable means. In general, any means of implementing the methodology illustrated herein can be used to implement the various aspects of the present invention. Exemplary hardware that can be used for the present invention includes computers, handheld devices, telephones (e.g., cellular, Internet enabled, digital, analog, hybrids, and others), and other such hardware. Some of these devices include processors (e.g., a single or multiple microprocessors), memory, nonvolatile storage, input devices, and output devices. Furthermore, alternative software implementations including, but not limited to, distributed processing, parallel processing, or virtual machine processing can also be configured to perform the methods described herein.

The systems and methods of the present invention may also be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Additionally, the data processing functions disclosed herein may be performed by one or more program instructions stored in or executed by such memory, and further may be performed by one or more modules configured to carry out those program instructions. Modules are intended to refer to any known or later developed hardware, software, firmware, artificial intelligence, fuzzy logic, expert system or combination of hardware and software that is capable of performing the data processing functionality described herein.

1. A method, comprising:
receiving an indication of a need for one or more grocery bags;
interrogating one or more detectable elements coupled to each grocery bag in the one or more grocery bags;
identifying at least one grocery bag to satisfy the need for the one or more grocery bags;
notifying a user that the at least one grocery bag is present within a specified distance; and
notifying the user of the location of the at least one grocery bag.

2. A system for tracking a grocery bag supply, comprising:
an electronically-detectable identification element coupled to at least one grocery bag;
a computing device capable of interrogating the electronically-detectable identification element;
a location tracking device coupled to the at least one grocery bag; and
an alerting mechanism communicatively coupled to the electronically-detectable identification element and the locating tracking device, the alerting mechanism capable of notifying a user when the user approaches a shopping location so that the user proceeds with the at least one grocery bag.
